(19) United States
(12) Patent Application Publication
(10) Pub. No.: US 2006/0265722 A1
(43) Pub. Date: Nov. 23, 2006

(54) Tray locking device for optical disc drive

(75) Inventors: Min Cheng Yang, Hsinchu (TW); Shih Lin Yeh, Hsinchu (TW)

Correspondence Address: BIRCH STEWART KOLASCH & BIRCH, PO BOX 747, FALLS CHURCH, VA, 22040-0747, US

(73) Assignee: Lite-On It Corporation

(21) Appl. No.: 11/194,558

(22) Filed: Aug. 2, 2005

(30) Foreign Application Priority Data
May 17, 2005 (TW) 094115921

(51) Int. Cl. G11B 17/04

(52) U.S. Cl. 720/610

(57) ABSTRACT

The present invention relates to a tray locking device for optical disc drive, which uses a driving element and a memory metal having different lengths at different temperature conditions to control the movement of the driving element to drive a locking mechanism. Accordingly, it attains the objects of simplifying its structure and saving assembling space, and avoids the breakage of the memory metal attributed to shocking force during drop test.

This Non-provisional application claims priority under 35 U.S.C. § 119(a) on Patent Application No(s). 094115921 filed in Taiwan, Republic of China on May 17, 2005, the entire contents of which are thereby incorporated by reference.

### FIELD OF THE INVENTION

The present invention relates to a tray locking device for optical disc drive, particular to a tray locking device for optical disc drive which is driven by a memory metal.

### BACKGROUND OF THE INVENTION

The tray locking device used in the slim type optical disc drive, according to its driving manner, is classified into a solenoid driving type and direct current (DC) motor driving type.

The solenoid driving type tray locking device mainly uses a magnetic attraction generated by the solenoid to disengage a hook from a lock pin and allow the tray locking in the optical disc drive. However, in a drop test for optical disc drive, the magnetic attraction is not enough to hold the hook in engaging with the lock pin, therefore the tray will slide out from the optical disc drive unexpectedly.

To resolve this problem, a DC motor driving type tray locking device is developed. To control the starting or stopping of the motor, in relevant designs, most of the DC motor driving type tray locking device use a switch to control the position of the hook. However, since the transmission of stopping signal from the switch might delay, the stop time of the motor is also late and the hook stops at an inappropriate position. In this regards, it might result in the locking device jamming.

Moreover, the solenoid and the DC motor driving type locking devices both include so many mechanical members or the hook driving manner is complex, it will occupy a lot of device space and is not easily to assemble so the assembly cost is increased. There needs further improvements to simplify the structure for attaining thinning of the device and cost down.

In the end, use of a memory metal to control the hook engaging with or disengaged from the lock pin has been developed. Such a typical design is shown in FIGS. 1 and 2. FIG. 1 is a schematic view showing a structure of conventional tray locking device, and FIG. 2 is a partial enlarging view of the tray locking device shown in FIG. 1. As shown in the Figures, the locking device is provided on a tray T and engages with a lock pin B1 provided on the inside wall of a housing (not shown in the Figures). Also, by using the property of the memory metal line L1 that its length varies with different temperatures, one end of a hook T1 is driven to allow the hook T1 spinning around a spinning axis T2 and the hook T1 is in turn released from the lock pin B1 to allow the tray Y carrying out of the optical disc drive.

However, although the use of memory metal line to control the locking device simplifies the constituting members and effectively drive the hook to release from the lock pin, but in the drop test for optical disc drive, the memory metal line will be broken down due to the dropping force. Thus it could not pass the drop test for optical disc drive.

Accordingly, the object of the present invention resides in a tray locking device for optical disc drive which has a simply structure and could withstand the dropping force generated in the drop test and achieve the purpose of cost down.

### SUMMARY OF THE INVENTION

The object of the present invention relates to a tray locking device for an optical disc drive which has a simply structure and thus saves its space occupied in the drive. The present tray locking device for optical disc drive resolves the problem of breaking of memory metal during the drop test for optical disc drive.

To achieve the above object, the present invention provides a tray locking device for optical disc drive, which includes:
a lock pin;
a locking mechanism having a hooking part, the hooking part shifts between a first position and a second position, and the hooking part is engaged with the lock pin when it is at the first position and the hooking part is released from the lock pin when it is at the second position;
a driving element which shifts between a third position and a fourth position; and
a memory metal connected with the driving element, wherein the memory metal has a first and a second lengths at different temperature conditions;
wherein the driving element is at the third position and the hooking part is at the first position when the memory metal has the first length; and
the driving element is at the fourth position and said hooking part is at the second position when the memory metal has the second length.

According to the embodiment of the present tray locking device, it further includes an elastic member which is connected with the hooking part and the tray. The elastic member provides elasticity for allowing the hooking part shifting from the second position back to the first position.

According to the embodiment of the present tray locking device, when the driving element is at the third position, it keeps a distance from the locking mechanism. Thereby, when the optical disc drive including the present tray locking device is subjected to the drop test, the dropping force generated in the test would not transfer to the memory metal through the driving element. As a result, the memory metal would not be broken down in the test.

The optical disc drive to be installed with the present tray locking device includes a tray on which optical modules such as a turntable, pick up unit, etc., are provided and a housing for accommodating the tray. The present tray locking device is used for controlling the lock/unlock of the tray in the housing.

### BRIEF DESCRIPTION OF DRAWINGS

The present invention is illustrated more detail by reference to the accompanying drawings, wherein:

FIG. 1 is a schematic view showing a structure of conventional tray locking device.

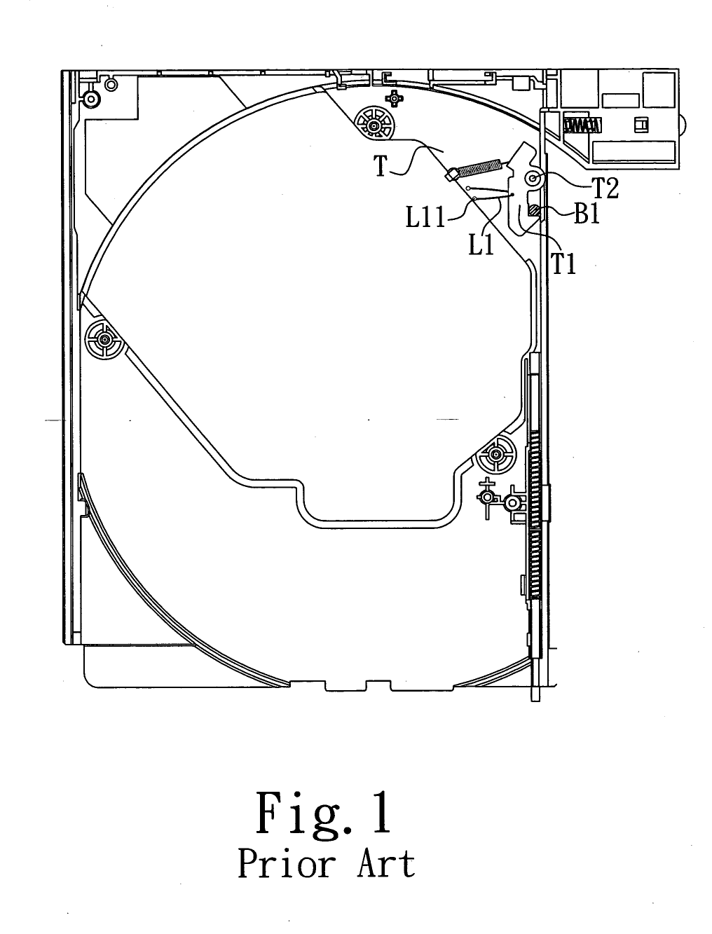

FIG. 2 is a partial enlarging view of the tray locking device shown in FIG. 1.

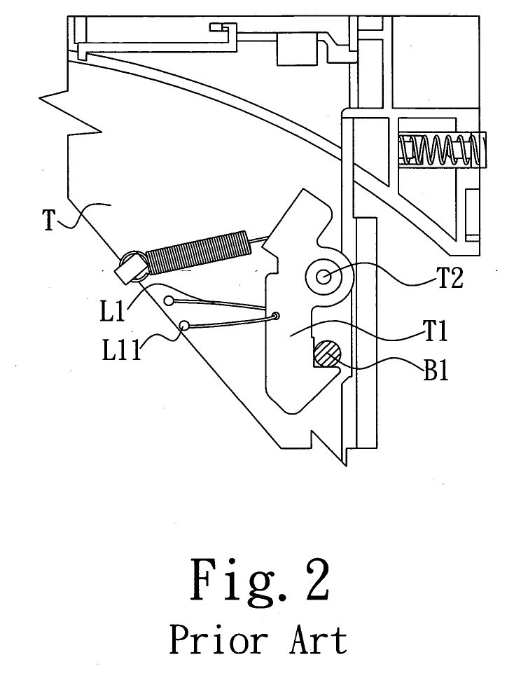

FIG. 3 is a schematic view showing an optical disc drive including the tray locking device of the present invention, in which the tray is carried out from the housing.

FIG. 4 is a schematic view showing a structure of one embodiment of the tray locking device of the present invention.

FIG. 5 is a partial enlarging view of the tray locking device shown in FIG. 4, in which the memory metal has the first length.

FIG. 6 is a partial enlarging view of the tray locking device shown in FIG. 4, in which the memory metal has the second length and the tray is carrying out from the housing.

FIG. 7 is a partial enlarging view of the tray locking device shown in FIG. 4, in which the tray is carrying into the housing.

### DETAILED DESCRIPTION OF THE INVENTION

The present invention is illustrated in more detail by reference the following preferred embodiments which are only used for illustration without limiting the scope of the present invention.

The present invention will be illustrated in more detail by reference to an embodiment in which the present tray locking mechanism is provided on a tray and a lock pin is provided on the inner wall of a housing. However, the present invention is not limited to the mentioned above. This is, the tray locking mechanism could be provided on the inner wall of a housing and a lock pin could be provided on a tray, as long as the tray locking mechanism is effectively engaged with the lock pin.

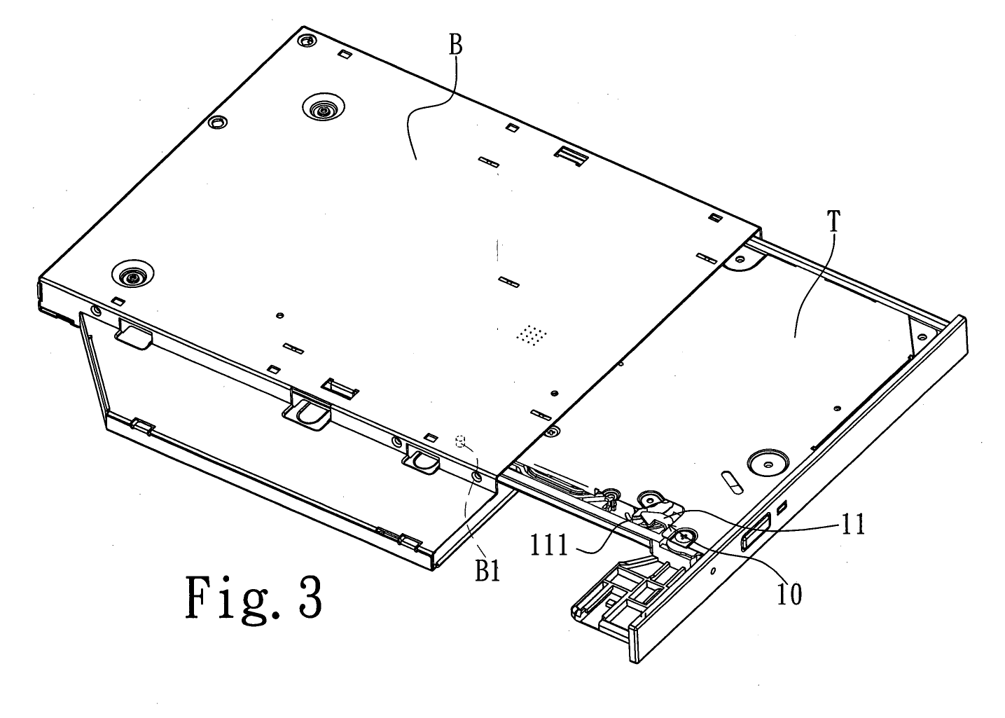

Please refer to FIG. 3. FIG. 3 is a schematic view showing an optical disc drive including the tray locking device of the present invention, in which the tray is carried out from the housing.

The present invention relates to a tray locking device for an optical disc drive in which the optical disc drive includes a housing B and an optical disc tray T on which a turntable and a pick up unit are provided (not shown in the Figures). The present tray locking device is used for controlling the lock/unlock of the tray T in the housing B. The tray locking device includes a lock pin B1, a locking mechanism 10, a driving element 20, and a memory metal 30, in which the lock pin B1 is provided on the inner wall of the housing B (as shown in FIG. 3) and the locking mechanism 10 is provided on the tray T corresponding to the lock pin B1.

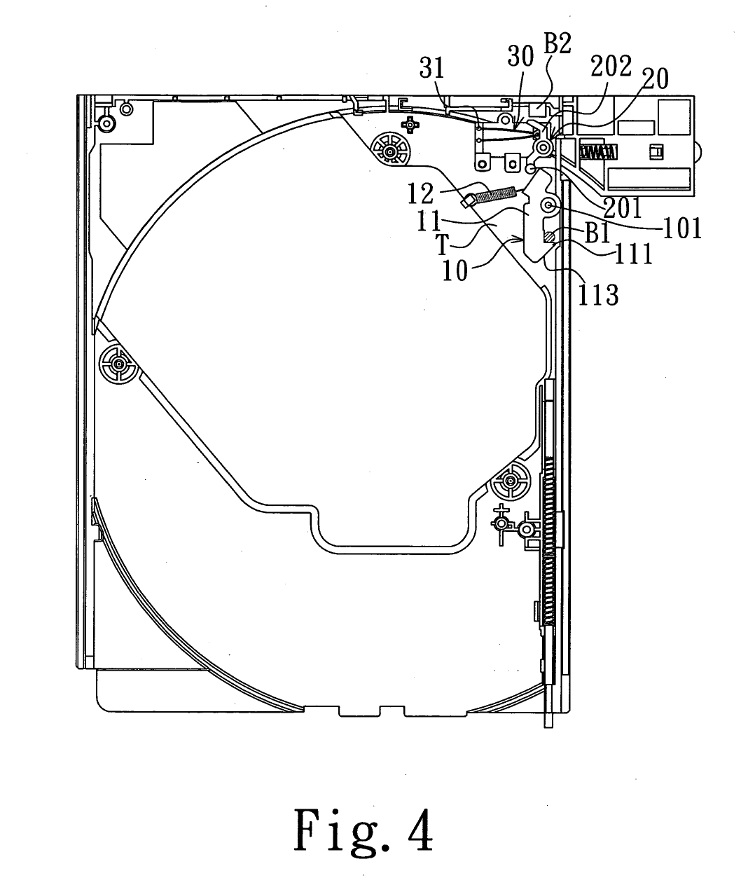

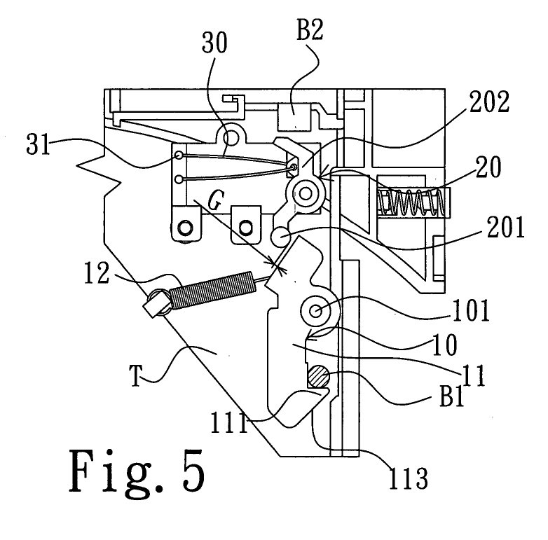

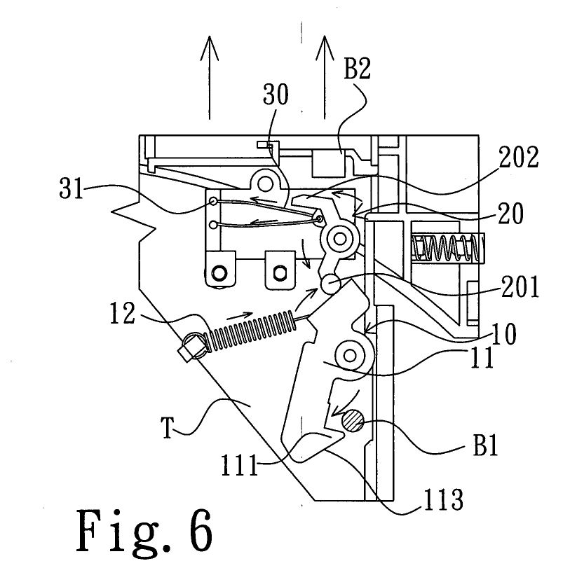

Please also refer to FIGS. 4 to 6. FIG. 4 is a schematic view showing a structure of one embodiment of the tray locking device of the present invention; FIG. 5 is a partial enlarging view of the tray locking device shown in FIG. 4, in which the memory metal has the first length; and FIG. 6 is a partial enlarging view of the tray locking device shown in FIG. 4, in which the memory metal has the second length and the tray is carrying out from the housing.

According to the present tray locking device, the locking mechanism 10 includes a hook 11 having a hooking part 111 for engaging with or releasing from the lock pin B1. The hook 11 can rotate on the tray around the spinning axis 101 to allow the hooking part 111 being shifted between the first position and the second position. When the locking part 111 is at the first position, the locking part 111 is engaged with the lock pin B1, as shown in FIG. 5. When the locking-part 111 is at the second position, the locking part 111 is released from the lock pin B1, as shown in FIG. 6.

However, the above locking mechanism could also be a linker mechanism consisting of a plural of connecting rods or any connecting mechanism, as long as the mechanism has a hooking part to engage with/release from the lock pin and can shift between the first and the second positions.

According to the present tray locking device, the driving element 20 is pivotally provided on the tray T and its one end 202 is connected with a memory metal 30 and the other end 201 is used to pull the locking mechanism 10. The driving element 20 can shift between the third position and the fourth position, as shown in FIGS. 5 and 6, to allow the end 202 pushing on or leaving the locking mechanism 10 to further control the engagement (disengagement) of the hooking part with (out from) the lock pin. In this embodiment, when the memory metal 30 has the first length, the driving element 20 is at the third position and the hooking part 111 is at the first position to allow the hooking part being engaged with the lock pin B1, as shown in FIG. 5. And when the memory metal 30 has the second length, the driving element 20 is driven to the fourth position and allows the end 201 driving the locking mechanism 10 to allow the hooking part 111 being moved to the second position and being released from the lock pin B, as shown in FIG. 6. Moreover, when the driving element 20 is at the third position and the hooking part 111 is at the first position, the end 201 keeps a distance G from the locking mechanism 10 to avoid the dropping force generated in the drop test to transfer to the memory metal 30 through the driving element 20. Thus the breakage of the memory metal would not occur during the test.

According to the present tray locking device, the memory metal 30 is provided on the tray by connecting parts 31. By using the property of the memory metal that it will shorten when heating, the memory metal 30 has the first length without heating and has the second length when electric power is applied to the connecting parts 31 to generate heat. When the memory metal 30 has the first length, the driving element 20 is at the third position and the hooking part 111 is at the first position. At this time, the tray locking device is in a lock state and there is a distance G between the driving element 20 and the locking mechanism 10. When the memory metal 30 has the second length, the driving element 20 is at the fourth position to allow the end 202 pushing on the locking mechanism 10 and allow the hooking part 111 moving to the second position. At this time, the tray locking device is in an unlock state and thus the tray could be carried out from the drive.

According to the present tray locking device, it further includes an elastic member 12 which is provided on the tray T and connected with said locking mechanism 10. The elastic member 12 provides elasticity for allowing the hook 11 shifting from the second position back to the first position.

According to the present tray locking device, when the tray T is to be carried out from the drive, electric power is applied to the connecting parts 31 of the memory metal 30 to allow the metal 30 changing its length from the first length to the second length. Thus the memory metal 30 pulls the driving element 20 moving from the third position to the fourth position, as shown in FIG. 6. In this time, the end 201 pushes the locking mechanism 10 to allow its hooking part 111 moving from the first position to the second position. Thus the hooking part 111 is released from the lock pin B1 and the tray T is in turn carried out from the drive.

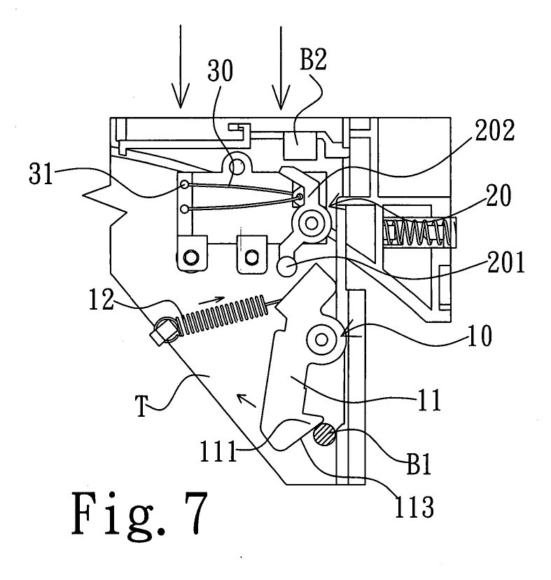

Please refer to FIG. 7. FIG. 7 is a partial enlarging view of the tray locking device shown in FIG. 4, in which the tray is carrying into the housing.

When the tray T is to be carried into the drive, the lock pin B1 is against the tilt edge 113 of the hooking part 111 and in turn pushes hooking part 111 to allow it moving from the first position to the second position and carrying the tray T into the drive. When the lock pin B1 leaves the tilt edge 113, the elastic member 12 provides elasticity for allowing the hooking part 111 shifting from the second position back to the first position and engaging with the lock pin B1. Thus the tray T is in a lock state in the drive.

According to the present tray locking device, a through hole B2 is provided on the tray near the driving element 20. The driving element 20 could be forcedly moved from the third position to the fourth position via the through hole B2 by using tool to push the hooking part 111 moving from the first position to the second position and releasing from the lock pin B1. Therefore if in emergency, user can forcedly carry the tray out from the drive.

According to the present tray locking device, the control of the engagement/disengagement of the locking mechanism from the lock pin is directly driven by the memory metal through the driving element. It simplifies the structure of the tray locking device and saves its assembly space, and it also effectively avoids the breakage of the memory metal during the drop test.

While the present invention has been particularly shown and described with reference to exemplary embodiments thereof, it will be understood by those of ordinary skill in the art that various changes and modifications may be made therein without departing from the spirit and scope of the present invention as defined by the following claims.

What is claimed is:

1. A tray locking device for optical disc drive, which comprises:
a lock pin;
a locking mechanism having a hooking part, said hooking part shifts between a first position and a second position, and the hooking part is engaged with said lock pin when it is at the first position and the hooking part is released from the lock pin when it is at the second position;
a driving element which shifts between a third position and a fourth position; and
a memory metal connected with said driving element, wherein said memory metal has a first and a second lengths at different temperature conditions;
wherein said driving element is at the third position and said hooking part is at the first position when said memory metal has the first length; and
said driving element is at the fourth position and said hooking part is at the second position when said memory metal has the second length.

2. The tray locking device for optical disc drive according to claim 1, wherein said driving element keep a distance from said locking mechanism when said memory metal has the first length.

3. The tray locking device for optical disc drive according to claim 1, which further comprises an elastic member which is connected with said locking mechanism and provides elasticity for allowing the hooking part shifting from the second position back to the first position.

4. An optical disc drive, which comprises:
a housing;
a tray on which a pick up unit and a turntable are provided; and
a tray locking device comprising:
a lock pin provided on the inner wall of said housing;
a locking mechanism provided on the tray and having a hooking part, said hooking part shifts between a first position and a second position, and the hooking part is engaged with said lock pin when it is at the first position and the hooking part is released from the lock pin when it is at the second position;
a driving element which shifts between a third position and a fourth position; and
a memory metal connected with said driving element, wherein said memory metal has a first and a second lengths at different temperature conditions;
wherein said driving element is at the third position and said hooking part is at the first position when said memory metal has the first length; and
said driving element is at the fourth position and said hooking part is at the second position when said memory metal has the second length.

5. The optical disc drive according to claim 4, wherein said driving element keep a distance from said locking mechanism when said memory metal has the first length.

6. The optical disc drive according to claim 4, wherein said tray locking device further comprises an elastic member which is connected with said locking mechanism and provides elasticity for allowing the hooking part shifting from the second position to the first position.

7. An optical disc drive, which comprises:
a housing;
a tray on which a pick up unit and a turntable are provided;
a lock pin provided on the inner wall of said housing;
a locking mechanism provided on the tray and having a hooking part for engaging with said lock pin;
a memory metal having a first length and a second length at different temperature conditions; and
a driving element connected with said memory metal and keeping a distance from said locking mechanism;
wherein when said memory metal changes its length from the first length to the second length, said driving element is driven to drive said locking mechanism and disengage the hooking part from said lock pin.

8. The optical disc drive according to claim 7, wherein said tray locking device further comprises an elastic member-which is connected with said locking mechanism and remains said locking mechanism to engage with said lock pin.
